(19) United States
(12) Patent Application Publication
(10) Pub. No.: US 2018/0169804 A1
(43) Pub. Date: Jun. 21, 2018

(54) CONTROL PANEL DISASSEMBLY APPARATUS AND METHOD

(71) Applicant: Caterpillar Inc., Peoria, IL (US)

(72) Inventors: Javier E. Tijerina Flores, Nuevo Laredo (MX); Laura P. Martinez Salazar, Nuevo Laredo (MX)

(73) Assignee: Caterpillar Inc., Peoria, IL (US)

(21) Appl. No.: 15/382,187

(22) Filed: Dec. 16, 2016

(51) Int. Cl. B23P 19/04; B23P 6/00

(52) U.S. Cl. CPC B23P 19/04; B23P 6/00

(57) ABSTRACT

A workstation for disassembling a control panel having a first side and a second side is disclosed. The workstation may include a fixture mounted to the workstation that receives the control panel to be disassembled. The workstation may further include at least two wedging tools that enter the control panel at two locations between the first and second sides of the control panel. In addition, the workstation may include at least two driving members that engage and edge of the first side at two locations and apply a force to the edge sufficient to separate the first side from the second side.

### TECHNICAL FIELD

The present disclosure generally relates to control panels and, more particularly, relates to an apparatus and method for disassembling control panels.

### BACKGROUND

Remanufacturing is a rapidly growing industry and philosophy. Remanufacturing means salvaging or removing used manufactured components, e.g., control panels from various machines, and processing the components in a manufacturing environment where they are efficiently and completely repaired and prepared for further life. Remanufactured components may then be returned to customers for additional service or used in rebuilt machines, for example. Remanufacturing extends the life of products, which results in cost savings, economy of resources and environmental benefits, as well as creating new revenue sources for manufactures. Of course, to retain their value, remanufactured components must be returned to a commercially and technically acceptable state.

While the automotive industry is well known for the remanufacturing of engine components, including pistons, bearings, valve components, pump components, etc., the remanufacturing of various machine components is also taking place. For example, generator sets may include remanufactured parts. A generator set is a self-contained power module that can be permanently or temporarily connected to an off-board facility, for example, to a home, a hospital or a factory, to provide primary, supplemental and emergency backup power. A generator set includes the combination of a generator and a prime mover, for example, a combustion engine. The generator and the prime mover are typically mounted together along with other accessories on an anchor platform to form an integral unit. As fuel is burned within the prime mover, a mechanical rotation is created that drives the generator to produce electrical power. Generator sets also typically include a terminal box, which houses the generator set controller and electronics used to monitor and control the generator set operation such that the electrical power is produced in a desired manner to have particular characteristics. The generator set controller may be in communication with the prime mover and the generator, and may include, among other things, a control panel. The control panel may be configured to monitor, protect and control both the generator and the engine. The control panel may include an integrated user interface or display panel, which may allow personnel to control and view different characteristics and responses of the generator set, as well as send instructions for execution. One example of a controller/control panel is an Electronic Modular Control Panel (EMCP). Such a control panel offers voltage and frequency monitoring of the generator, as well as temperature, pressure and speed monitoring of the engine.

The display panel/user interface of a control panel may include a screen for providing information to the operator. Additionally, all generator and engine controls, diagnostics and operating information may be accessible using the display panel keypads. The display panel may also employ a tactile screen. The display panel may include a frame or housing, which may server as the attachment point between the control panel and the generator set. The control panel also typically includes a back cover fixed to the display panel backside. The back cover of the control panel may cover the main electrical circuit board of the control panel, which is typically disposed behind the display panel. Where remanufacturing of generator sets is concerned, the control panels may be one of the components in need of repair. Specifically, in the remanufacturing setting, the electrical circuit boards of control panels may be removed and repaired. Further, the display panel, the electrical circuit board and the back cover must also be cleaned and cleared of any contamination. After such repairs, functional tests may then be performed to validate that all elements of the control panel are again working properly.

However, during the remanufacturing process, in order to access and remove the electrical board of a control panel for repair, personnel is required to disassemble the control panel, specifically, separate the back cover from the display panel. The back cover and display panel may be secured together using screws or other fasteners. In addition, RTV silicone (room temperature vulcanization silicone) or another adhesive may have been used between the back cover and the display panel to further secure these components together. Therefore, in addition to removing the screws or other fasteners that secure the back cover to the display panel, personnel must also break the silicone seal between these elements, which may have hardened significantly over time. In the past, this separation has required personnel to manually separate the back cover using impact force tools and/or hand-held blades or other sharp tools inserted between the back cover and the display panel in order to then pry the back cover from the display panel, breaking the silicone seal there between. This manual process presents safety risks to the worker. This manual process also risks further damaging the display panel, the electrical board and/or the back cover, thereby rendering the remanufacturing process less efficient or even futile. German Patent Number DE202004019324U1 discloses a method for disassembling screen devices, such as televisions or computer monitors; however, the disclosed method is not applicable to typical control panel configurations and is not for remanufacturing purposes, and in fact destroys the brackets and frame around the screen in order to remove the screen therefrom. Accordingly, it would be beneficial to provide a solution for safely and efficiently disassembling a control panel or separating the display panel from the back cover that leaves all disassembled elements of the control panel intact for the remanufacturing process.

### SUMMARY

In accordance with one aspect of the present disclosure, a workstation for disassembling a control panel having a first side and a second side is disclosed. The disclosed workstation may include a fixture mounted to the workstation, the fixture configured to receive the control panel. The workstation may also include at least two wedging tools configured to enter the control panel at two locations between the first side and the second side. In addition, the workstation may include at least two driving members configured to engage an edge of the first side at two locations, and to apply a force to the first side edge sufficient to separate the first side from the second side.

In accordance with another aspect of the present disclosure, a workstation for disassembling a control panel having a display panel and a back cover is disclosed. The workstation may include a fixture mounted to the workstation, the fixture configured to receive the control panel. The disclosed workstation may further include at least two horizontally displaceable wedging tools configured to enter the control panel at two locations between the display panel and the back cover. In addition, the workstation may include at least two vertically displaceable driving members configured to engage an edge of the display panel at two locations, and to apply a force to the display panel edge sufficient to separate the display panel from the back cover.

In accordance with another aspect of the present disclosure, a method of separating a back cover and a display panel of a control panel is disclosed. The disclosed method may include the steps of providing a workstation having a fixture for receiving the control panel, at least two wedging tools and at least two driving members. The method may also include the step of actuating the wedging tools to enter the control panel at two locations between the display panel and the back cover. In addition, the method may include the step of actuating the driving members to engage an edge of the display panel at two locations and to apply a force to the display panel edge sufficient to separate the display panel from the back cover.

These and other aspects and features of the present disclosure will be better understood when read in conjunction with the accompanying drawings.

### BRIEF DESCRIPTION OF THE DRAWINGS

FIG. 1 is a plan view of an exemplary control panel for disassembly according to the teachings of the present disclosure.

FIG. 2 is a perspective view of the backside of the control panel of FIG. 1, including the back cover mounted thereon.

FIG. 3 is a perspective view of the backside of the control panel of FIG. 1 having the back cover removed.

FIG. 4 is a perspective view of an exemplary workstation for disassembling the control panel of FIG. 1.

FIG. 5 illustrates a portion of the workstation of FIG.4 having the wedging tools in a retracted position.

FIG. 6 illustrates a portion of the workstation of FIG.4 having the wedging tools in an actuated position.

FIG. 7 illustrates an interior portion of the workstation of FIG. 4.

FIG. 8 illustrates the actuation of the driving members in the interior portion of the workstation.

FIG. 9 illustrates the separation of the display panel from the back cover according to the teachings of the present disclosure.

FIG. 10 illustrates the delivery of the back cover to the conveyor of the workstation.

FIG. 11 illustrates the delivery of the back cover out of the workstation.

FIG. 12 is a block diagram illustrating a method for separating a back cover and a display panel of a control panel according to the teachings of the present disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION

The present disclosure is directed to a workstation and a method for disassembling a control panel. While the disclosed embodiments of workstations are described in a remanufacturing setting, this disclosure is equally applicable in any environment where the disassembly of control panels is required. In addition, the control panel depicted in this disclosure is a control panel typically associated with a generator set; however, the workstation and methods of this disclosure may be applicable to control panels of any device, including construction equipment, agricultural equipment, home and other appliances, manufacturing machinery, vehicles, etc. Moreover, while the present disclosure is directed to the disassembly of control panels, it should be appreciated that the term “control panel” is meant to include any similar user interface, display panel, screen device, tablet, etc., and that the disclosed workstation and methods for disassembly are equally applicable to those devices. Such devices may or may not include a housing or frame, and an electrical board therein, so long as the separation of two sides or the removal of a back cover or back side is required during disassembly.

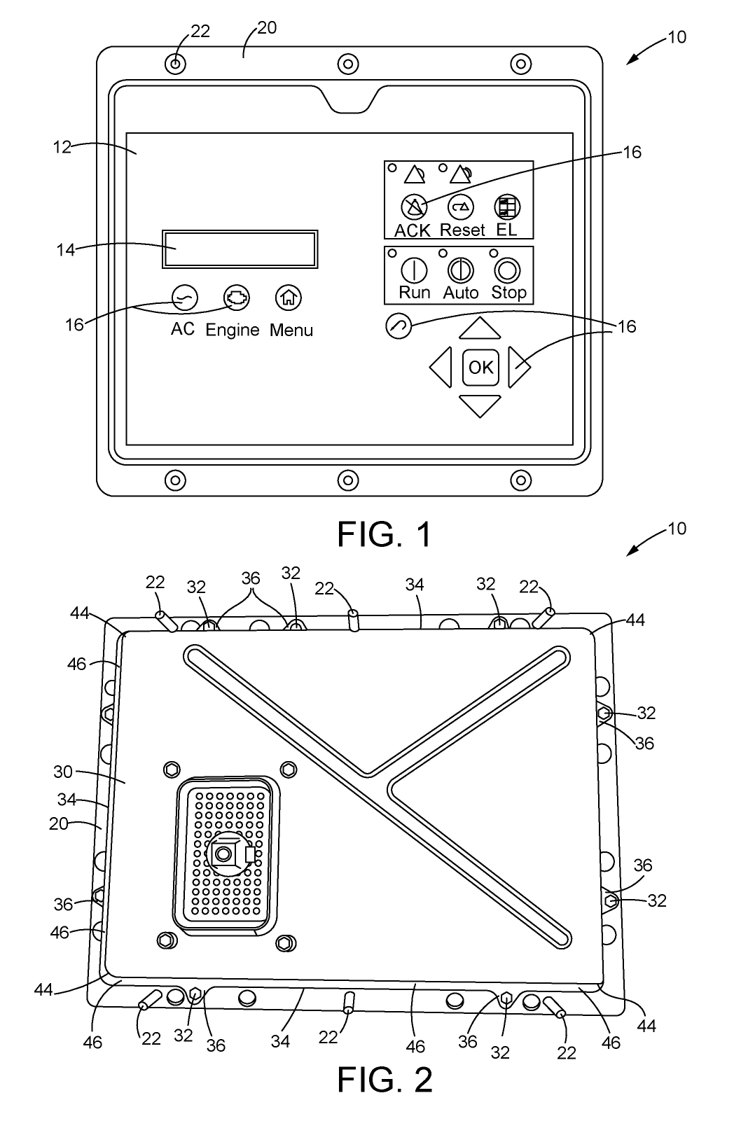

FIG. 1 illustrates a front side of a typical control panel 10 of a generator set. For example, the control panel 10 may be one of several versions of the Electronic Modular Control Panel (EMCP). The control panel 10 includes a display panel 12 having a screen 14 for displaying information regarding the various generator set parameters. The control panel 10 also includes numerous actuation and other generator control buttons 16 that allow an operator to control the generator set and to access information about the generator set parameters, operation and history. Among other things, the generator control buttons 16 may include an AC overview key, an engine overview key, an alarm key and/or an escape key, as well as navigation keys. The control panel 10 may include a keypad, push buttons, and/or may respond to tactile signaling. In addition, the control panel 10 may include a display panel housing 20 for framing the display panel 12 and for mounting the display panel 12 to the generator set. For example, the housing 20 may receive bolts 22, or any other known fasteners, for securing the display panel 12 to the generator set, most typically the terminal box of the generator set.

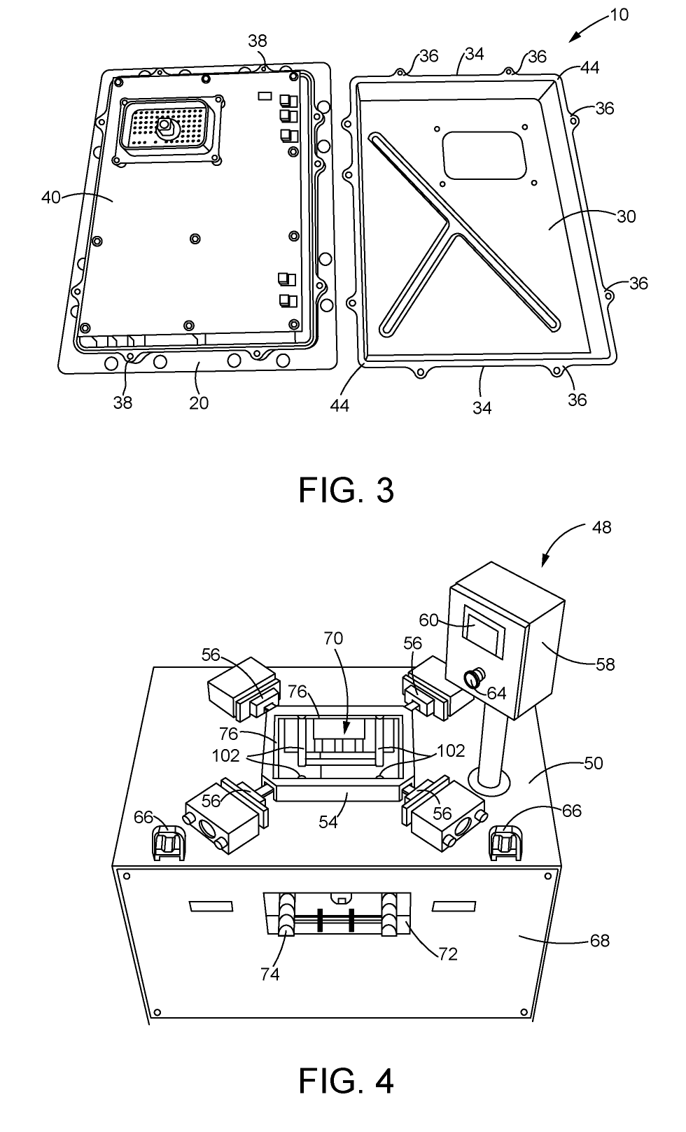

FIG. 2 illustrates an opposite side of the control panel 10. Specifically, FIG. 2 depicts a backside of the control panel 10 having a back cover 30 mounted thereon. The back cover 30 may be mounted directly onto the control panel 10 using screws 32 or any other appropriate fasteners known in the art. Specifically, the back cover 30 may include an edge 34 having tabs 36 which include an opening for receiving the screws 32 that secure the back cover 30 to the control panel 10. As seen in FIG. 3, the control panel 10 may include an interior frame or backside of the display panel 12 having tabs 38 extending there from that correspond with the back cover tabs 36. In this manner, the tabs 36, 38 may be aligned when the back cover 30 is placed onto the display panel 12 backside, and screws 32 or other fasteners may secure the back cover 30 to the display panel 12. It should be appreciated that the back cover 30 may be secured by screws 32 or other fasteners to the display panel 12 backside or to the housing 20 of the display panel 12. For the purposes of this disclosure, with regard to the disassembly of the control panel 10, separation of the back cover 30 is generally referred to as separation from the display panel 12, which is meant to include any element associated with the display panel 12. It should also be appreciated that while the depicted embodiments include a back cover 30 that is slightly smaller in size than the display panel 12, this disclosure may also be applicable to a control panel having the opposite sizing. For example the display panel 12 could be slightly smaller than the back cover 30. In this manner, the back cover 30 may provide an additional frame element around the display panel 12, and it may be the display panel housing 20 or the back cover 30 which is used to mount the control panel 10 to the generator set. In all cases, the back cover 30 functions to cover and protect the main electrical circuit board 40 housed in the interior of the control panel 10, as seen in FIG. 3.

In order to further secure the back cover 30 to the control panel 10 and to further protect the interior space and the main electrical circuit board 40 of the control panel 10 from contamination, a silicone layer may be used to seal the back cover 30 to the display panel 12. While not visible in the Figures, an RTV silicone, or any adhesive, may be applied along the slightly planar back cover edge 34 around and between tabs 36 to provide an additional bond between the back cover 30 and the display panel 12. This additional bond may exist along the entire edge 34 of the back cover 30, including the corners 44 of the back cover 30. An overlap area 46 of the back cover edge 34 with the display panel 12, where the silicone seal is employed, is indicated in FIG. 2 around the perimeter of the back cover 30. It should be appreciated the this silicone seal between the back cover edge 34 to the display panel 12 may be between the back cover edge 34 and any element associated with the display panel 12, including the display panel housing 20. The silicone seal may prevent, or at least reduce, the contamination of the interior space of the control panel 10 by unclean or polluted air from the generator set or work environment. This additional seal therefore helps to preserve the integrity of the main electrical board 40 and the operation of the generator set as a whole.

Where disassembly of the control panel 10 is concerned, the present configuration of the control panel 10 requires both the removal of screws 32, as well as the disruption of the silicone seal in order to separate the back cover 30 from the display panel 12. FIG. 4 illustrates a workstation 48 having a platform 50 on which the disassembly of the control panel 10 may take place. Prior to arriving to the workstation 48, any bolts 22 and screws 32 are removed from the control panel 10. The workstation 48 may include a fixture 54 for receiving the control panel 10, the fixture 54 being mounted to the platform 50. Associated with the fixture 54 and also mounted on the platform 50 are horizontally displaceable wedging tools 56. The workstation 48 may also include a monitor 58 for initiating and controlling the disassembly operation. This monitor 58 may be in communication with and control all moving parts of the workstation 48 in ways commonly understood in the industry. In addition, the monitor 58 may receive information from various sensors of the workstation 48 and control the disassembly operation in response thereto, as described further below. Among other things, the monitor 58 may include a user interface 60 and an emergency stop button 64. The user interface 60 may be used by personnel to initiate and program the disassembly operation. When necessitated, the emergency stop button 64 may be pushed to stop all operations of the workstation. Specifically, once the stop button 64 is pushed, all electricity and power (pneumatic, hydraulic or otherwise) may be cut, causing the workstation 48 and the disassembly operation to immediately shut down. The workstation 48 may also, for safety purposes, include a double button activation system 66. As explained further below, the double button activation system 66 may require that personnel charged with disassembly of the control panel 10 manually engage the double button activation system 66 with both hands throughout the disassembly operation, thereby ensuring that their hands are immobilized and free from any potential injury risk that may be presented by the moving parts of the workstation 48 during the disassembly operation. The workstation 48 may also include a front panel 68, as well as side and back panels (not shown) that house an interior 70 of the workstation 48. The front panel 68 may include an opening or delivery port 72 therein. Towards the end of the disassembly operation, this delivery port 72 may deliver part of the disassembled control panel 10, for example, the back cover 30, out of the workstation 48 via a conveyor 74.

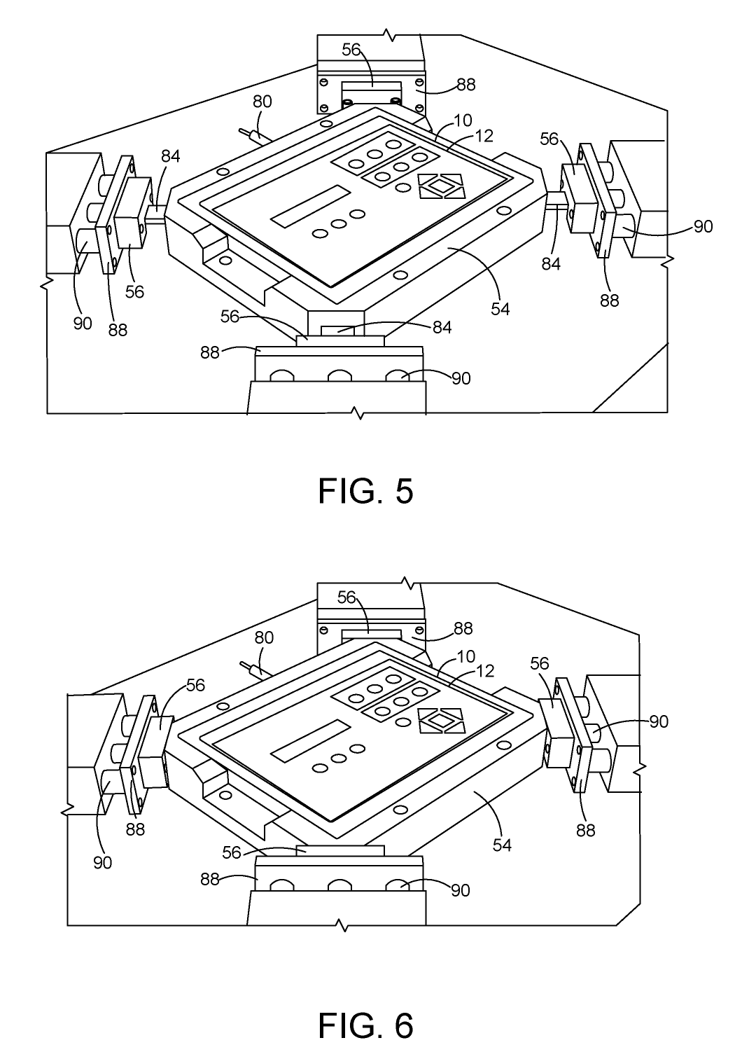

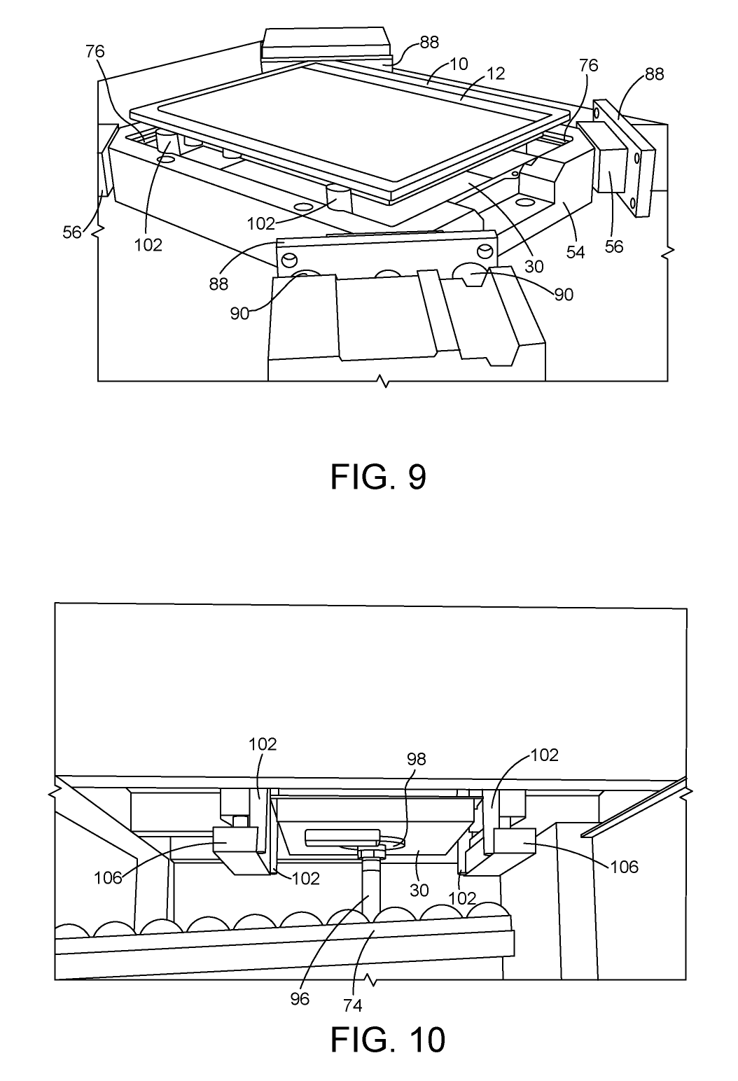

Before disassembly of the control panel 10, or separation of the back cover 30 from the display panel 12 using the workstation 48 can take place, all screws 32 or other fasteners are removed. However, as described above, the silicone seal between the back cover 30 and the display panel 12 may continue to hold the back cover 30 to the display panel 12. The workstation 48 is designed to break this additional silicone attachment and therefore separate the back cover 30 from the display panel 12, all the while preserving the structure and integrity of the control panel elements, as described below with reference to FIGS. 5-11. FIGS. 5 and 6 illustrate the placement and immobilization of the control panel 10 in the fixture 54. Specifically, the outside edge of the backside of the display panel 12 is received in a seat 76 of the fixture 54 (shown in FIGS. 4 and 9). While the fixture 54 is designed for the exact dimensions of the present control panel 10, it should be appreciated that the workstation 48 may accommodate a fixture for receiving a control panel of any shape or size, so long as any other implicated working parts of the workstation 48 are adjusted accordingly. The fixture 54 may receive the control panel 10 with the display panel 12 facing up and the back cover 30 facing the interior 70 of the workstation 48. In this manner, the backside of the display panel 12 and the back cover 30 are contained within the elevated frame of the fixture 54, only the front side of the display panel 12 being exposed. As explained above, the back cover 30 of the control panel 10 may be slightly smaller than the outside edge of the display panel 12. For this reason, it is only this outside edge of the display panel 12 that is received in the fixture seat 76. As also described above, it should be appreciated that it may instead be the back cover 30 that is slightly larger than the display panel 12. In such a case, the outside edge of the back cover may be received in the fixture seat 76, with the display panel facing the interior 70 of the workstation 48. The fixture 54 may include a sensor 80 that detects the correct placement and immobilization of the control panel 10 in the fixture 54, and such a sensor 80 may be in communication with the monitor 58. This detection of a control panel 10 secure in the fixture 54 may be required for the workstation 48 to be activated and for the disassembly operation to proceed.

FIGS. 5 and 6 also illustrate the movement of the horizontally displaceable wedging tools 56. Specifically, FIG. 5 illustrates four wedging tools 56 in a retracted position while FIG. 6 illustrates the four wedging tools 56 in an actuated position. Each of the wedging tools 56 includes a blade 84 mounted to or integral with the wedging tool 56, which may extend, at least partially, within the fixture 54, as depicted in FIG. 5. The wedging tools 56 are horizontally displaceable on the platform 50 towards the fixture 54. The wedging tools 56 may be mounted to an advancing member 88 that operates to move the wedging tools 56 to and from the fixture 54. While the depicted embodiments include advancing members 88 mounted to pneumatically operated pistons 90, any device or power known in the industry may be employed to move the wedging tools 56 towards the fixture 54. Other power options may include mechanical power and/or hydraulic power. In addition, while the four wedging tools 56 and the four blades 84 are depicted as exposed in the Figures, the wedging tools 56 and/or the blades 84 may be contained within a housing fixed directly to the fixture 54, thereby avoiding any safety risks presented by exposed, moving blades 84. The blades 84 of the wedging tools 56 may be positioned at a level relative to the control panel 10 such that the blades 84 are aligned with the overlap areas 46 proximate the edge of the control panel 10 where the back cover 30 overlaps with the display panel 12. As described above, this continuous area 46 of overlap along the perimeter of the back cover 30 is also where the silicone seal secures the back cover 30 to the display panel 12. Actuation of the wedging tools 56 advances the wedging tools 56 and blades 84 towards and into the fixture 54. After traversing the fixture 54, the blades 84 reach and wedge into the immobilized control panel 10 at the areas 46 of overlap between the back cover edge 34 and the display panel 12, thereby at least partially disrupting the silicone seal between the back cover 30 and the display panel 12. While the wedging tools 56 are depicted in the Figures as proximate the four corners 44 of the control panel 10, and therefore the blades 84 are also depicted as entering at the corners 44 of the control panel 10, the wedging tools 56 and blades 84 may be disposed anywhere along the fixture 54 so long as the blades 84 are positioned to enter the control panel 10 at the overlapping area 46 between the display panel 12 and the back cover 30 when the control panel 10 is immobilized in the fixture 54. Further, while the disclosed embodiments include wedging tools 56 employing blade elements, any relatively thin, pointed, and/or sharp edged element capable of insertion between the display panel 12 and the back cover 30 may be utilized.

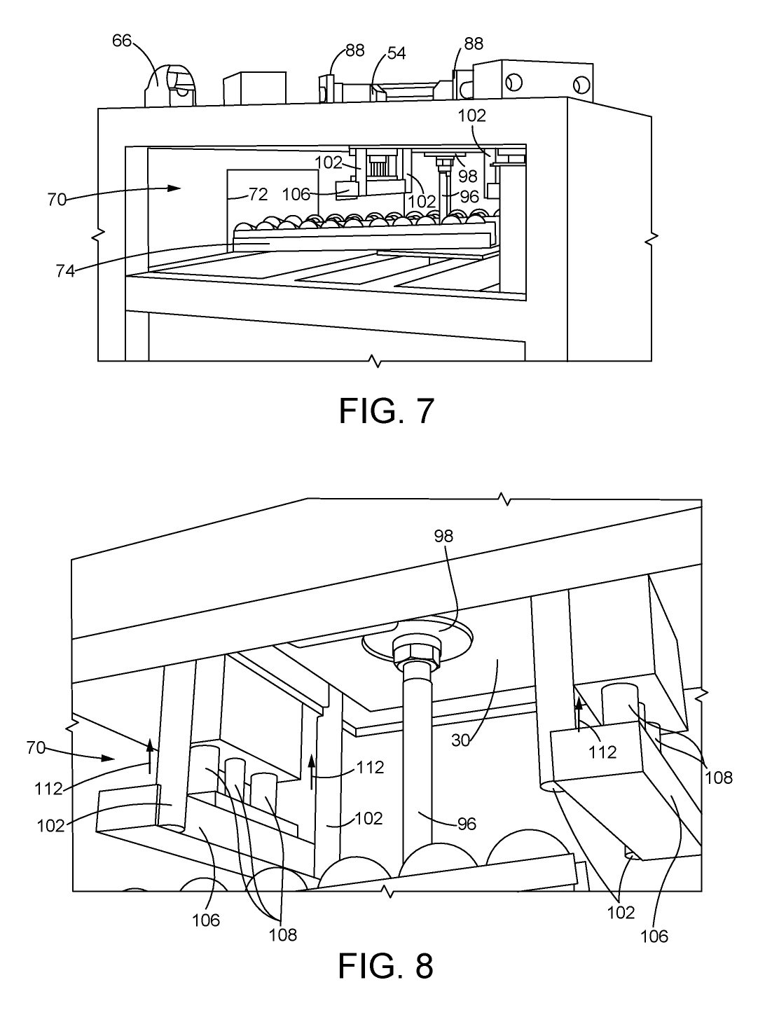

Once the control panel 10 is secured in the fixture 54 and further immobilized by the blades 84 that have entered the control panel 10 between the back cover 30 and the display panel 12, separation of the display panel 12 from the back cover 30 may take place. Turning to FIGS. 7 and 8, which illustrate an interior 70 of the workstation 48, a cylinder 96 is depicted as extending vertically from proximate the conveyor 74 to the back cover 30 of the control panel. The cylinder 96 may be a pneumatically powered cylinder or piston. Any manner known in the industry may likewise be used to power the cylinder 96, including mechanical or hydraulic power. The cylinder 96 includes a seat 98 and the cylinder 96 operates to vertically displace the seat 98 from a lowered position proximate the conveyor 74 to a raised position where the seat 98 is in contact with the back cover 30 of the control panel 10, as depicted in FIGS. 7 and 8. The cylinder 96 may be maintained in the raised position throughout the above-described placement of the control panel 10 in the fixture 54 and the actuation of the wedging tools 56. Alternatively, the cylinder 96 may be raised to contact the back cover 30 once the wedging tools 56 have been actuated and the blades 84 have entered the control panel 10. In all cases, the cylinder 96 and seat 98 may operate to hold the back cover 30 once the back cover 30 is separated from the display panel 12, as described below.

FIGS. 7 and 8 also illustrate four vertically displaceable driving members 102 mounted to a base 106. The driving members 102 and the bases 106 may be vertically displaced via pistons 108, which may operate using pneumatic power. Likewise, the displacement of the driving members 102 may be powered by any manner known in the industry including mechanical or hydraulic power. Prior to the actuation or vertical displacement of the driving members 102, the upper ends of the driving members 102 may be disposed within the fixture 54, the top surface of the driving members 102 being disposed at the same level as the seat 76 that receives the outside edge of the display panel 12 (see FIG. 4). In this manner, when the control panel 10 is placed in the fixture 54, the backside edge of the display panel 12 that is received in the seat 76 is also in contact with the upper ends of the driving members 102. Actuation of the driving members 102 completely ruptures the silicone seal and separates the back cover 30 from the display panel 12. Specifically, once actuated, the driving members 102 are uniformly raised as indicated by arrows 112. This vertical displacement of the driving members 102 raises the upper ends of the driving members 102 from the level of the seat 76, which simultaneously engages and applies a force against the outside edges of the display panel 12 backside, as best illustrated in FIG. 9. Because the wedging tools 56 have previously been actuated to enter the control panel 10 between the back cover 30 and the display panel 12, the back cover 30 is restrained between the blades 84 of the wedging tools 56 and the cylinder seat 98. In this manner, the upwardly directed force applied to the display panel 12 by the driving members 102, being sufficient to break the silicone seal, simultaneously breaks the silicone seal between the display panel 12 and the back cover 30 and lifts the display panel 12 off of the back cover 30. At this point, the display panel 12 may be manually picked up or removed from the workstation 48 by personnel. The Figures illustrate the workstation 48 as including four wedging tools 56 at each corner of the fixture 54, as well as four driving members 102 disposed along the edges of the fixture 54 so as to ultimately contact the edges of the display panel 12. However, it should be appreciated that the workstation 48 may include only two wedging tools 56 and two driving members 102, so long as they are situated on opposite sides of the control panel 10 or fixture 54 and can function to enter the control panel 10 and force the separation of the two sides (the display panel 12 and the back cover 30).

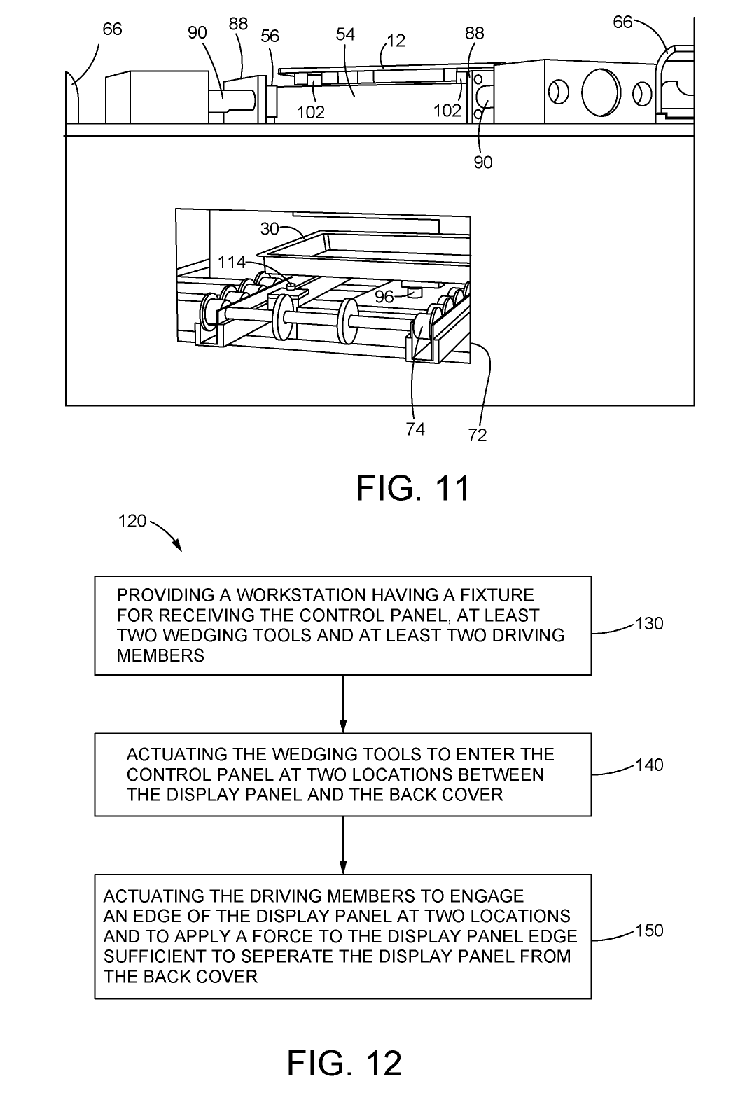

As seen in FIGS. 9 and 10, while the display panel 12 is lifted out of the fixture 54 by the driving members 102, the back cover 30 of the disassembled control panel 10 remains inside the fixture 54 where it is held by the seat 98 of the cylinder 96. The cylinder 96, described above as vertically displaceable, may deliver the back cover 30 from the fixture 54 to the conveyor 74 within the interior 70 of the workstation 48. Specifically, the cylinder 96 and the seat 98 may vertically descend under pneumatic pressure or release, or otherwise, until the back cover 30 is received onto the conveyor 74. As indicated in the Figures, the cylinder 96 may be proximate the conveyor 74 or between opposite sides of the conveyor 74. Once received on the conveyor 74, the back cover may then be delivered out of the workstation through the delivery port 72, as illustrated in FIG. 11. A sensor 114 may also be included in the interior 70 of the workstation 48, for example, mounted to the conveyor 74. This sensor 114 may detect the presence of the back cover 30 on the conveyor 74 and its delivery out of the workstation 48. In this manner, the sensor 114, which is in communication with the monitor 58, may signal that the disassembly of the control panel 10 is complete and that all moving parts of the workstation 48 may return to their non-actuated positions. Specifically, the wedging tools 56 may be retracted and the driving members 102 may descend back to their non-actuated, lowered positions where their maximum height is at the same level as the fixture seat 76. At this point, the workstation 48 is ready and available to receive another control panel 10 for disassembly.

FIG. 12 is a block diagram illustrating a method 120 of separating a back cover and a display panel of a control panel. With reference to the drawings generally, the method 120 may include: a first step 130 of providing a workstation 48 having a fixture 54 for receiving the control panel 10, at least two wedging tools 56 and at least two driving members 102. As described above, the wedging tools 56 may be horizontally displaceable, and the driving members 102 may be vertically displaceable. Thereafter, the method 120 of separating a back cover and a display panel of a control panel may include: the step 140 of actuating the wedging tools 56 to enter the control panel 10 at two locations between the display panel 12 and the back cover 30. This step 130 may include blades 84 of the wedging tools 56 entering the control panel 10 at areas 46 of overlap between the back cover edge 34 and the display panel 12. Finally, the method 120 of separating a back cover and a display panel of a control panel may include: the step 150 of actuating the driving members 102 to engage an edge of the display panel 12 at two locations and to apply a force to the display panel edge sufficient to separate the display panel 12 from the back cover 30. As described above, this step 150 may include raising the driving members 102 against the display panel edge with a force sufficient to rupture any silicone seal that exists between the display panel and the immobilized back cover 30, in turn separating the two sides.

As mentioned above, the workstation 48 and methods of this disclosure may be equally applicable to a control panel having a back cover that is slightly larger than the display panel. In such a case, the back cover edges may be received in the fixture seat 76 and may receive the upwardly directed force from the driving members 102 while the display panel is received onto the cylinder seat 98 and ultimately delivered onto the conveyor 74 and out of the workstation 48. Likewise, it should be appreciated that while the workstation 48 is depicted and described as including horizontally displaceable wedging tools 56, and vertically displaceable driving members 102, all moving parts of the workstation may be tilted at different angles or completely inverted so long as the wedging tools 56 operate to enter the control panel between the two sides (the display panel and the back cover) and the driving members 102 operate to force the larger of the two sides away from the restricted smaller side. In addition, while the interior 70 of the workstation 48 is described as including the conveyor 74 for delivering one of the sides out of the workstation 48, this conveyor 74 need not be present, and instead, personnel could be responsible for retrieving both sides of the separated, disassembled control panel 10 out of the fixture 54 once the disassembly operation is completed.

### INDUSTRIAL APPLICABILITY

Remanufacturing of parts and equipment has become commonplace in many industries. The remanufacturing of generator sets may involve the removal and repair of the control panels associated therewith. In order to repair a control panel, the removal of the main electrical circuit board housed inside the control panel may be required. The main electrical board may require repair or may simply need to be cleared of contamination. Likewise, all parts of the control panel may require decontamination after an extended period of use in a work environment. In order to repair and decontaminate a control panel, it must first be disassembled. The disclosed workstation 48 and method 120 may have applicability in manufacturing or remanufacturing environments where control panels or other devices, such as similar user interfaces, display panels, screen devices, tablets, etc., are to be disassembled. The control panels depicted in this disclosure are a control panels typically associated with generator sets; however, this disclosure may have applicability with any control panel, including control panels of construction equipment, agricultural equipment, appliances, manufacturing machinery, vehicles, etc.

A typical control panel 10 may include a back cover 30 mounted to a display panel 12. The back cover 30 may be mounted using screws 32, for example, to a backside of the display panel 12, the display panel housing 20 or any other frame or member associated with the display panel 12. For the purposes of this disclosure, separation of the back cover 30 is generally referred to as separation from the display panel 12, which should be appreciated to include separation from any element associated with the display panel 12. The back cover 30 may include an edge 34 that overlaps with the display panel 12 at areas 46 along the perimeter of the back cover 30. As described above, this area 46 of overlap may include a silicone seal meant to further secure the back cover 30 to the display panel 12 and to insulate the interior of the control panel 10 from contamination. Therefore, in order to disassemble the control panel 10, not only do the screws 32 need to be removed, which occurs before the control panel 10 is received in the presently disclosed workstation 48, but also the silicone seal between the back cover 30 and the display panel 12 must be broken so that the two sides may be separated. Over time and extended use of the control panel 10 in a work environment, this silicone seal may harden significantly, making the rupture of this silicone seal and the separation of the sides more difficult than one might expect.

In the past, after removing the screws 32, personnel charged with disassembly of the control panel 10 has been required to use impact force tools and to manually insert a sharp tool, such as a knife, into the control panel 10 along the area 46 of overlap between the back cover 30 and the display panel 12, and thereafter manually pry the two sides apart. Not only is this manual method of disassembly of the control panel 10 inefficient, it risks damaging the parts of the control panel, including the display panel, the back cover and/or the main electrical circuit board housed therein. In addition, this method of manually disassembling the control panel 10 using a knife or other sharp tool may result in physical injury to the personnel charged with the disassembly.

The disclosed workstation 48 and method 120 automate the disassembly of control panels 10, improving the efficiency at which the disassembly may occur, as well as avoiding any risk of damage to the control panel parts and any risk of injury to personnel. For disassembly of the control panel 10, personnel at the workstation 48 may first set up the operation or enter the desired program manually into the monitor 58 mounted to the workstation 48. This initial set up may occur through the user interface 60. Thereafter, the worker may place a control panel 10 to be disassembled into the fixture 54. The control panel 10 of the present embodiments is placed into the fixture 54 with the display panel 12 facing up and the back cover 30 facing down and contained inside the fixture 54. As described above, the edge of the display panel 12 may be received on a seat 76 of the fixture 54. As also described above, it should be appreciated that the orientation of the sides may be reversed such that the back cover 30 faces up while the display panel 12 faced down, depending on the particular dimensions of the control panel at hand. Once in place in the fixture 54, disassembly of the control panel 10 may proceed.

The workstation 48 may be provided with a sensor 80, which may be mounted to the fixture 54 and configured to detect the correct placement and immobilization of the control panel 10 in the fixture 54. This sensor 80 may be in communication with the monitor 58, and detection of a control panel 10 secure in the fixture 54 may be required for the disassembly operation to proceed. In addition, the workstation 48 may be provided with a double button activation system 66. The double button activation system 66 may require manual engagement of the system 66 by both hands of the worker. Specifically, for the disassembly operation to proceed, the worker may be required to place the control panel 10 into the fixture 54 and thereafter grasp the double button activation system 66, one button in each hand. The system 66 may be in communication with the monitor 58, which may then actuate the additional steps of the disassembly operation. This double button activation system 66 is a safety measure for ensuring that the worker's hands are in a safe place and at no risk of injury before the moving parts of the workstation 48 are actuated. The system 66 may require that the worker's hands are in place throughout the entirety of the disassembly operation, or may only require placement on the buttons during part of the disassembly operation, for example, actuation of the wedging tools 56, which may include the movement of blades 84 or other sharp objects on the workstation 48.

The disassembly of the control panel 10 further includes the actuation of the wedging tools 56 and the actuation of the driving members 102. As described above and depicted in the Figures, actuation of the wedging tools 56 may include the horizontal displacement of the wedging tools 56, including blades 84, such that the tools enter the control panel 10 immobilized in the fixture 54. Specifically, the blades 84 may enter the control panel 10 at the area 46 of overlap between the back cover 30 and the display panel 12, thereby at least partially disrupting the silicone seal there between. While the edge of the display panel 12 is received in the seat 76 of the fixture 54 and held thereby, the back cover 30 may be held by the vertically displaceable cylinder 96 within the interior 70 of the workstation 48. Next, the driving members 102 may be vertically displaced to engage and direct an upwardly directed force against the edges of the display panel 12, the force being sufficient to rupture the silicone seal between the back cover 30 and the display panel 12, in turn lifting the display panel 12 off of the back cover 30, which is anchored down by the blades 84 and seated on the cylinder 96. At this point in the disassembly operation, the display panel 12 is completely separated form the back cover 30, which may be deposited by the cylinder 96 onto the conveyor 74 for delivery out of the workstation 48. The delivery of the back cover 30 out of the workstation 48 may be detected by the sensor 114, which may communicate this termination of the disassembly operation to the monitor 58. The monitor 58 may in turn signal for the return of the wedging tools 56 and the driving members 102 to their non-actuated positions. In this manner, the workstation 48 is then ready and available to receive an additional control panel 10 for disassembly.

The presently improved automated method of disassembling a control panel provides an efficient disassembly of the control panel 10 while preserving the integrity of the various parts of the control panel 10. Specifically, the disclosed workstation 48 allows quick disassembly without the use of any impact force tools on the control panel 10. In this manner, the display panel 12, the back cover 30 and the main electrical board 40, as well as any other elements housed within the control panel 10, may be repaired and refurbished for reuse without having received any additional damage during the disassembly process. Furthermore, the disclosed workstation 48 and methods prioritize worker safety by avoiding the risks presented when a worker is charged with manually forcing disassembly of the control panel 10 using hand-held blades or other sharp tools.

All references to the disclosure or examples thereof are intended to reference the particular example being discussed at that point and are not intended to imply any limitation as to the scope of the disclosure more generally. Also, it will be apparent to those skilled in the art that various modifications and variations can be made to the workstation of the present disclosure without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being indicated by the following claims.

What is claimed is:

1. A workstation for disassembling a control panel having a first side and a second side, comprising:
a fixture mounted to the workstation, the fixture configured to receive the control panel;
at least two wedging tools configured to enter the control panel at two locations between the first side and the second side; and
at least two driving members configured to engage an edge of the first side at two locations, and to apply a force to the first side edge sufficient to separate the first side from the second side.

2. The workstation of claim 1, further comprising a cylinder configured to receive the second side.

3. The workstation of claim 2, further comprising a conveyor configured to receive the second side from the cylinder and to deliver the second side out of the workstation.

4. The workstation of claim 1, wherein the wedging tools comprise blades.

5. The workstation of claim 1, wherein the wedging tools are horizontally displaceable.

6. The workstation of claim 5, wherein the driving members are vertically displaceable.

7. The workstation of claim 1, further comprising a double button activation system.

8. A workstation for disassembling a control panel having a display panel and a back cover, comprising:
a fixture mounted to the workstation, the fixture configured to receive the control panel;
at least two horizontally displaceable wedging tools configured to enter the control panel at two locations between the display panel and the back cover; and
at least two vertically displaceable driving members configured to engage an edge of the display panel at two locations, and to apply a force to the display panel edge sufficient to separate the display panel from the back cover.

9. The workstation of claim 8, further comprising a vertically displaceable cylinder configured to receive the back cover.

10. The workstation of claim 9, further comprising a conveyor configured to receive the back cover from the cylinder and to deliver the back cover out of the workstation.

11. The workstation of claim 8, wherein the at least two horizontally displaceable wedging tools comprise four blades.

12. The workstation of claim 8, wherein the control panel includes four corners, and wherein the four wedging tools enter the control panel proximate the four corners, and wherein four driving members apply force to the display panel edge between the four corners.

13. The workstation of claim 8, further comprising a monitor configured to initiate disassembling of the control panel by the workstation, the monitor being in communication with sensors on the workstation.

14. The workstation of claim 8, further comprising a double button activation system.

15. A method of separating a back cover and a display panel of a control panel, comprising:
providing a workstation having a fixture for receiving the control panel, at least two wedging tools and at least two driving members;
actuating the wedging tools to enter the control panel at two locations between the display panel and the back cover; and
actuating the driving members to engage an edge of the display panel at two locations and to apply a force to the display panel edge sufficient to separate the display panel from the back cover.

16. The method of claim 15, further comprising the step of providing a vertically displaceable cylinder to hold the back cover.

17. The method of claim 16, further comprising the step of providing a conveyor configured to deliver the back cover from the cylinder out of the workstation.

18. The method of claim 15, wherein actuating the wedging tools horizontally displaces four wedging tools.

19. The method of claim 15, wherein actuating the driving members vertically displaces four driving members.

20. The method of claim 15, further comprising the step of providing a double button activation system, and the step of manually engaging the double button activation system before any actuation step.
